(19) United States
(12) Patent Application Publication
(10) Pub. No.: US 2015/0335104 A1
(43) Pub. Date: Nov. 26, 2015

(54) PET LEASH CLASP

(71) Applicant: Robert G. Dickie, King City (CA)

(72) Inventor: Robert G. Dickie, King City (CA)

(21) Appl. No.: 14/719,391

(22) Filed: May 22, 2015

Related U.S. Application Data
(60) Provisional application No. 62/001,713, filed on May 22, 2014.

(51) Int. Cl. A44B 13/02; A01K 27/00

(52) U.S. Cl. CPC A44B 13/02; A01K 27/001; A01K 27/003

(57) ABSTRACT

A clasp for engaging a pet leash to a pet collar and a method of using the same is disclosed. The clasp includes a first member having first and second ends; a second member having first and second ends; and a pivot pin securing the second ends together. A D-ring secures the leash to the second end of one of the members. The first ends are selectively movable toward and away from each other. The user will grasp the clasp between a thumb and index finger of one hand and position the clasp so that an aperture in a ring on the pet collar is aligned with opposing jaws on the first ends of the members. The user will then squeeze the first and second members together to move the jaws toward each other; and the ring will be secured between the members as they interlock.

### CROSS-REFERENCE TO RELATED APPLICATION

This application claims the benefit of U.S. Provisional Patent Application Ser. No. 62/001,713, filed May 22, 2014, the entire specification of which is incorporated herein by reference.

### BACKGROUND

1. Technical Field

This invention relates generally to products for pets. More particularly, this invention is directed to leashes for pets. Specifically, this invention is directed to a clasp for securing a pet leash to a pet collar, where the clasp has a pivot at one end and jaws at the other end; and the jaws are biased into an open position; and where side members of the clasp are squeezed toward each other to engage a ring on the pet collar and are interlocked with each other to secure the ring within the clasp.

2. Background Information

In order to secure a leash to a pet's collar, the leash must somehow be secured to a ring on the collar. The engagement of the leash with the collar when worn by the animal may be problematic, particularly if the pet is in training or is eager to move. Movement of the pet at the wrong moment makes it quite difficult to engage a clip at the end of the leash onto the ring on the collar. Part of the problem stems from the fact that currently known clips have a spring-loaded slider that has to be withdrawn so as to clear an opening between two opposing jaws on the clip. It is difficult to stop the clip's slider from moving back under spring tension while trying to see the opening. At the same time it is necessary to capture and manipulate the collar's clip so that it will be engage the collar ring. If the pet is moving this process is even more difficult because one hand is occupied holding onto the collar and all of the other motions, including restraining the spring-biased slider and manipulating the clip into the correct position to capture the ring, have to be accomplished with the other hand. Frequently, just as the correct positioning of all components is achieved, the user's finger will slip off the slider and the opening to the clip will close, necessitating that the whole process be started again. This problem is particularly difficult if the pet in question is a larger animal, such as a large breed dog.

It is also difficult to disengage previously known leash clips from a pet collar ring. In this instance, the user has to hold the clip, move and hold back the slider, and then turn the clasp through 90 degrees from the load direction to try and unhook the clip from the ring. It is not particularly easy to turn the clip through 90 degrees while trying to hold the slider back. If you do not hold the slider back ahead of time, the ring will be in contact with the slider pin, pulling the slider pin sideways and thereby preventing the same from being withdrawn.

### SUMMARY

There is therefore a need in the art for an improved pet leash clasp which enables the clasp to more easily engage a collar ring and to be more easily disengaged therefrom.

Such an improved clasp is disclosed herein. The clasp includes a first member having first and second ends; a second member having first and second ends; and a pivot pin securing the second ends together. A D-ring secures the leash to the second end of one of the members. The first ends are selectively movable toward and away from each other in a pincer-like motion. The default position is that the clasp is in the open position, ready to engage a ring on a pet collar. When the clasp is used, the user will grasp the opposing sides of the clasp between a thumb and index finger of one hand and position the clasp so that an aperture in the ring on the pet collar is aligned with opposing jaws on the first ends of the clasp. The user will then squeeze the first and second members together to move the jaws toward each other; and the ring will be secured between the members as they interlock. A trigger extends from the first member to the second member and the trigger interlocks with second member and has to be actively released in order to enable the first and second members to once again move apart from each other.

In one aspect, the invention may provide a clasp for engaging a pet leash to a pet collar; said clasp including a first member having a first end and a second end; a second member having a first end and a second end; and a pivot pin securing the second ends of the first and second members together; wherein the first ends of the first and second members are selectively movable toward and away from each other; and the first ends are adapted to capture and secure a ring on the pet collar when moved toward each other and to release the ring when moved away from each other.

In another aspect, the invention may provide in combination a pet collar adapted to be secured around a pet's neck; said collar having a ring extending outwardly therefrom; and a pet leash having a clasp on one end, where the clasp includes a first member having a first end and a second end; a second member having a first end and a second end; and a pivot pin securing the second ends of the first and second members together; wherein the first ends members are selectively movable toward and away from each other; and the first ends are moved toward each other to capture the ring on the pet collar; and the first ends are movable away from each other to release the ring.

In yet another aspect, the invention may provide a method of securing a pet leash to a pet collar including providing a clasp on the pet leash, where the clasp has first and second members that are pivotally secured together at one end and have opposing jaws at an opposite end, and where the jaws are biased into an open position; grasping the clasp between a thumb and index finger of one hand; positioning the clasp so that an aperture in a ring on the pet collar is aligned with the opposing jaws on the clasp; squeezing the first and second members together to move the jaws toward each other; and interlocking the jaws together.

In another aspect, the step of interlocking the jaws together may further provide engaging a trigger on the first member in an aperture on the second member as the first and second members move toward each other.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims.

FIG. 1 is a top view of a pet collar engaged with a PRIOR ART pet leash clip; and

FIG. 2 is a top view of the pet collar showing the PRIOR ART pet leash clip being engaged with the pet collar;

FIG. 3 is a perspective view of a pet leash clasp securing a leash to a pet collar;

FIG. 4 is a first perspective view of the pet leash clasp shown in a closed position;

FIG. 5 is a second perspective view of the pet leash clasp shown in the closed position;

FIG. 6 is a front elevational view of the pet leash clasp in an open position;

FIG. 7 is an exploded perspective view of the pet leash clasp;

FIG. 8 is a cross-sectional rear view of the pet leash clasp in the closed position;

FIG. 9 is a perspective bottom view of a trigger shown removed from the pet leash clasp;

FIG. 9a is a side elevational view of the trigger of FIG. 9;

FIG. 10 is a first perspective view of the first member of the pet leash clasp;

FIG. 11 is a second perspective view of the first member of the pet leash clasp;

FIG. 12 is a first perspective view of the second member of the pet leash clasp; and

FIG. 13 is a second perspective view of the second member of the pet leash clasp.

Similar numbers refer to similar parts throughout the drawings.

### DETAILED DESCRIPTION

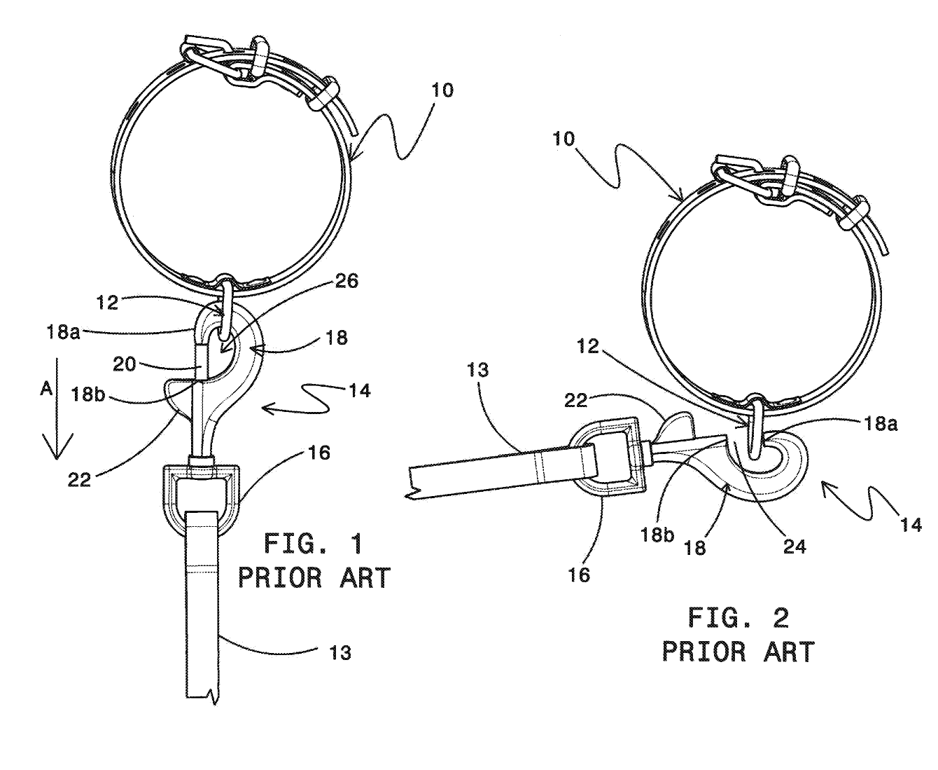

Referring to FIGS. 1 and 2 there is shown a pet collar 10 which includes a ring 12 suitably anchored to collar 10 so that a leash 13 may be engaged with collar 10. A PRIOR ART pet leash clip is illustrated in these figures and is generally indicated at 14. PRIOR ART pet leash clip 14 includes a D-ring 16 to which leash 13 is engaged. Pet leash clip 14 further includes a hook member 18 having a spring-loaded slider 20 (FIG. 1) that is movable by a button 22 in a first direction. When button 22 is moved in the first direction “A” toward D-ring 16, slider 20 is retracted into a chamber within hook member 18. The movement of slider 20 opens a gap 24 between a first jaw 18a of hook member 18 and a second jaw 18b thereof. It should be noted that first and second jaws 18a, 18b are stationary and do not move relative to each other. The only moving component on clip 14 is slider 20. Button 22 has to be continuously pushed in the direction “A” to keep this gap 24 open long enough to allow the user to manipulate clip 14 so that ring 12 will enter gap 24. When ring 12 is sufficiently entered into gap 24 so that first and second jaws 18a, 18b will be aligned with an aperture defined in the collar ring 12, button 22 is released and the spring-loaded slider 20 will move in the opposite direction to arrow “A”. Slider 20 will return to its default closed position, closing off gap 24 and thereby capturing ring 12 within the space 26 defined by hook member 18. If the user accidentally releases button 22 too early, then ring 12 will not be captured and the entire process will have to be started once again. It should be noted that the gap 24 between first and second jaw members 18a, 18b is on the side of the clip 14.

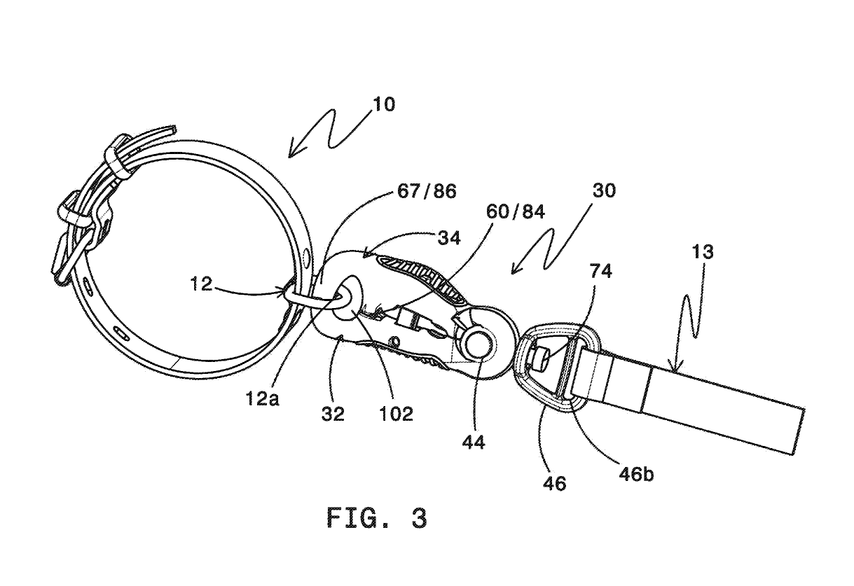

Referring now to FIGS. 3-13 there is shown an improved pet leash clasp which overcomes many of the issues of the PRIOR ART clip 14. The improved pet leash clasp is indicated in FIGS. 3-13 by the reference number 30. Clasp 30 is used in connect a leash 13 to a pet collar 10. Clasp 30 is engaged with pet collar 10 via ring 12 that is anchored to collar 10 and this ring defines an aperture 12a (FIG. 3) therein.

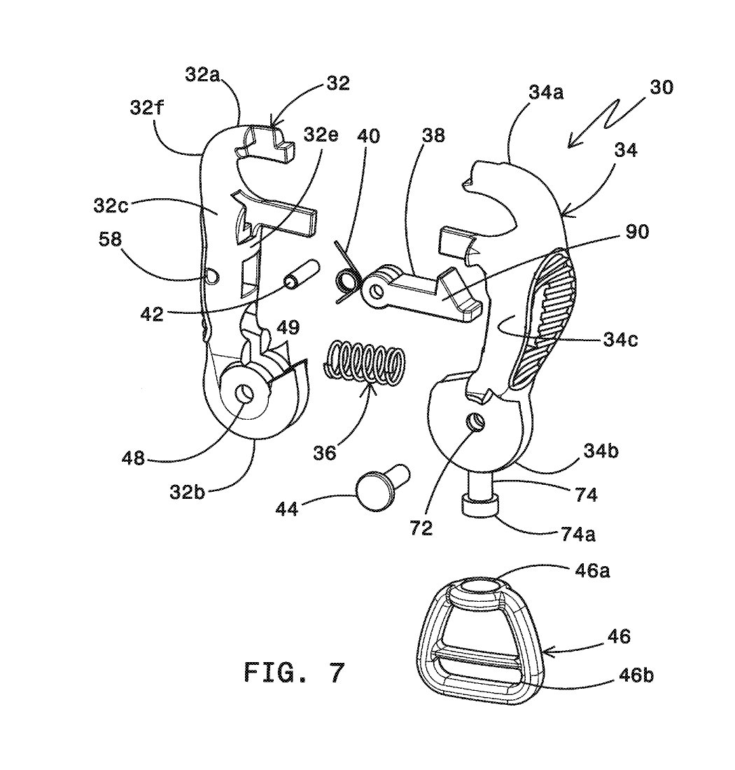

Clasp 30 includes a body comprised of a first member 32 and a second member 34 that are pivotally secured together at one end and present movable jaws at the other end. The first and second members 32, 34 are able to move between a default open position and a closed position where they interlock with each other as will be described further herein. FIG. 7 is an exploded view of clasp 30 and it shows that in addition to first and second members 32, 34, clasp 30 further includes a coil spring 36, a trigger 38, a torsion spring 40, a trigger pivot pin 42, a pivot pin 44, and a D-ring 46. Leash 13 (FIG. 3) is engaged with D-ring 46.

First and second members 32, 34 may be molded from a suitable material and are configured to interlock with each other. Suitable materials for fabrication of first and second members include any tough plastic or glass-filled nylon. These materials ensure that clasp 30 is lighter than a metal clasp, is not susceptible to corrosion as would be the case with a metal claps, may be fabricated in a variety of aesthetically pleasing bright colors; and because the clasp is not metallic, sounds that could be generated between the collar 10 and clasp 30 are substantially reduced relative to previously known clips. Each of the first and second members 32, 34 is molded to include complementary surfaces and projection/recess combinations that allow the inner walls of the first and second members 32, 34 to dovetail and interlock with each other. It will be understood, that first and second members 32, 34 may alternatively be die cast from metal or may be fabricated from any other suitable material. Additionally, the specific shapes of the first and second members 32, 34 is by way of example only and other differently shaped first and second members could be utilized.

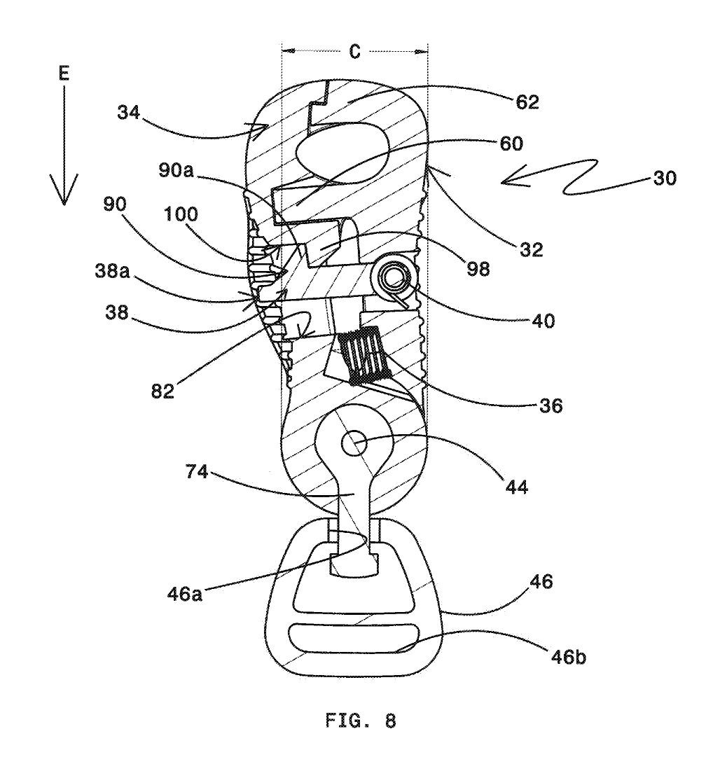

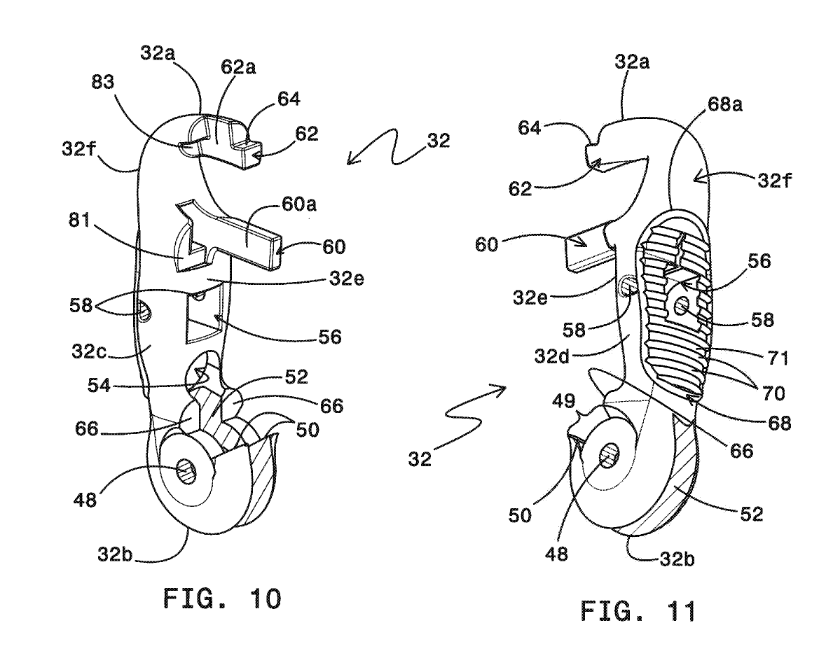

First member 32 is illustrated in FIGS. 10 and 11 and includes a first end 32a, a second end 32b, a front side 32c, a back side 32d, an inner wall 32e and an outer wall 32f. First member 32 has a longitudinal axis which extends between first and second ends 32a, 32b and is disposed generally at right angles thereto. The region of first member 32 proximate second end 32b is generally circular in shape and has an exterior perimeter surface that is of a circumference “C” (FIG. 8). A notch 49 (FIG. 11) is provided in the exterior circumferential surface. Notch 49 defines a shoulder region 66 adjacent inner wall 32e and a lip region 50 opposed to the shoulder region 66. The purpose of this notch 49 will be discussed later herein.

A through-hole 48 is defined in the generally circular region and this hole 48 extends from front side 32c through to back side 32d of first member 32 and is oriented at right angles to the longitudinal axis of first member 32. Second end 32b also defines a slot 52 that extends generally parallel to the longitudinal axis of first member 32. Slot 52 divides this generally circular region into two spaced-apart parallel sections, each having a hole 48 therein. Inner wall 32e of first member 32 includes a pair of spaced apart shoulders 66 which flank slot 52 and are generally parallel to the outer wall 32f.

A recess 54 is defined in inner wall 32e a distance inwardly from the second end 32b and, more particularly, further inwardly of the generally circular region. Recess 54 does not extend the whole way from inner wall 32e through to outer wall 32f. Instead, recess 54 terminates a distance inwardly from outer wall 32f. Recess 54 may be generally circular in shape and is configured to receive one end of coil spring 36 therein. The end of coil spring 36 may simply be seated in recess 54 or may be secured in an appropriate manner to the material of the first member 32.

An aperture 56 is defined in inner wall 32e a distance further inwardly and toward first end 32a from recess 54. Aperture 56 extends from inner wall 32e through to outer wall 32f, as can be seen in FIG. 11. Aperture 56 is configured to receive one end of trigger 38 therein and may be generally square in shape. If trigger 38 is differently shaped to what is illustrated in the figures then aperture 56 will be accordingly differently shaped. A through-hole 58 is defined in first member 32 and extends from front side 32c through to back side 32d. Hole 58 intersects aperture 56 and is configured to receive pin 42 therethrough to anchor one end of trigger 38, as will be further described herein.

First member 32 also includes a blade 60 and a jaw 62 that project outwardly from inner wall 32e and toward second member 34. Blade 60 extends outwardly from inner wall 32e for a greater distance than does jaw 62. Each of the blade 60 and jaw are situated adjacent the back side 32d of first member 32 and do not extend the entire width of inner wall 32e (i.e., the blade and jaw 60, 62 do not extend laterally from front side 32c to back side 32d of first member). Each of the blade and jaw 60, 62 may be disposed at right angles to the longitudinal axis “Y” of first member 32. Blade 60 is provided to extend at least part way across an opening between first and second members 32, 34 when clasp 30 is in an open position. The positioning of blade 60 is such that trigger 38 will be positioned between blade 60 and second ends 32b, 34b. Blade 60 is provided to protect trigger 38 from accidental engagement by clip 12. Jaw 62 is provided to extend through an aperture 12a of ring 12 when clasp 30 is engaged with collar 10. Jaw 62 defines a notch 64 in an upper surface thereof that is configured to interlock with a portion of inner wall 34e of second member 34. Each of the blade and jaw 60, 62 presents a substantially planar interior face 60a, 62b (FIG. 10).

FIG. 11 shows that outer wall 32f defines a shallow depression 68 which is bounded by an exterior rim 68a. Depression 68 is shaped and sized to approximate a top region of a person's finger or thumb. A plurality of alternating ribs 71 and troughs 71 are provided in depression 68 to provide a frictional surface that helps a person grip clasp 30. Ribs 70 and troughs 71 are oriented generally at right angles to the longitudinal axis of first member 32. Ribs 70 and troughs 71 may be provided above and below aperture 56 and adjacent either side thereof. Aperture 56 is thus surrounded by ribs and troughs 70. It will be understood that other suitable textures or finishes may be applied in depression 68 to improve a person's grip on clasp 30.

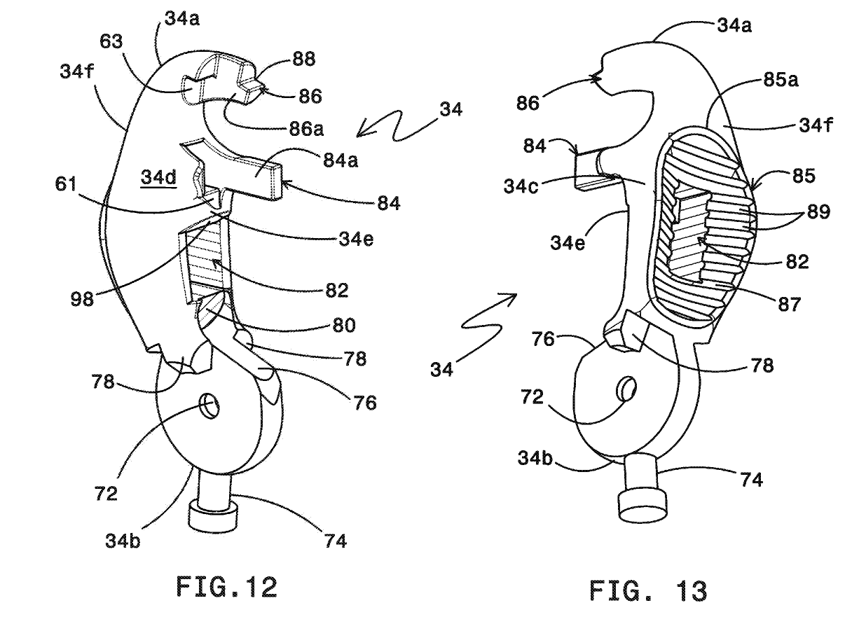

Referring now to FIGS. 12 and 13 there is shown the second member 34 of clasp 30 in greater detail. Second member 34 has a first end 34a, a second end 34b, a front side 34c, a back side 34d, an inner wall 34e and an outer wall 34f. A longitudinal axis of second member 34 extends between first and second ends 34a, 34b and is positioned generally at right angles thereto. Second end 34b includes a generally circular region that has a width that is complementary to the lateral width of slot 52. Additionally, the generally circular region at second end 34b is of a circumference substantially identical to circumference “C” of the generally circular region of first member 32. When first and second members 32, 34 are interlockingly engaged with each other, the generally circular region at second end 34b of second member 34 is received in the slot 52 of first member 32. The exterior perimeters of the generally circular regions at second end 32b and second end 34b and generally aligned with each other.

A hole 72 is defined in the generally circular region proximate second end 34b and is oriented substantially at right angles to the longitudinal axis of second end 34b. When first and second members 32, 34 are engaged, hole 72 will align with hole 48 and pivot pin 44 is passed through the aligned holes 48, 72 to secure first and second members 32, 34 together. Pivot pin 44 may comprise any one of a number of different types of fastener that allows pivoting motion between first and second members, and may include fasteners such as a rivet. The pivot arrangement between first and second members 32, 34 is an interlocked design which aids in maintaining proper alignment between first and second members 32, 34.

As best seen in FIG. 8, a post assembly 74 is insert-molded into the material of second member 34. Post assembly 74 is die cast from metal to provide a strong connection for D-ring 46. The upper portion of post assembly 74 extends to beyond the hole 72 and a hole (not numbered) is defined in the upper portion so that pin 44 will additionally be received therethrough. The metallic upper portion of post assembly 74 provides additional strength to second member 34 and thereby a stronger leash connection.

During fabrication the D-ring 46 is formed with a round hole 46a (FIG. 7) defined therein. This round hole allows an enlarged bottom end 74a of post assembly 74 which is positioned a distance beneath second end 34b of second member 34 to be inserted therethrough. The upper end of D-ring 46 is then pressed to an oval shape so that bottom end 74a of post 74 can no longer pass therethrough. This secures D-ring 46 to second member 34 in such a way that. D-ring 46 is able to rotate about an axis extending along the shaft of post assembly 74. Leash 13 is threaded through an aperture 46b in a lower region of D-ring 46 and is secured back on itself. Other ways of attaching leash 13 to the D-ring 46 may also be utilized.

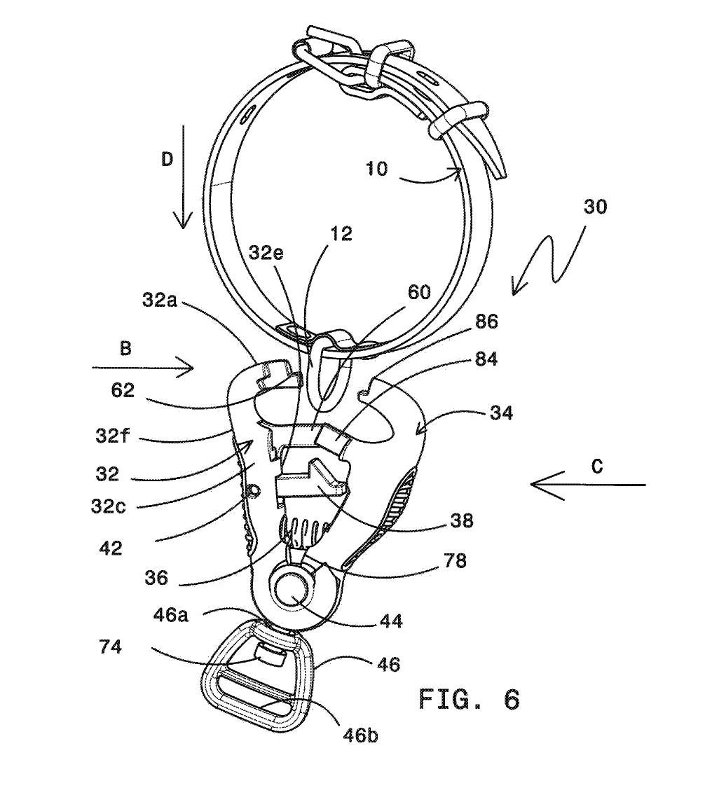

The generally circular region proximate second end 34b of second member 34 includes a generally planar upper surface 76. A pair of projections 78 flanks planar surface 76 and extend downwardly therefrom. Projections 78 are terminal regions of front and back sides 34c, 34d of second member 34. Projections 78 include a variety of angular surfaces which are complementary to surfaces on lip region 50 and shoulder region 66 of first member 32. When first and second members 32, 34 are interlockingly engaged with each other the projections 78 are received in notches 49. Projections 78 are smaller than notches 49 and this ensures that first and second members 32, 34 are able to pivot relative to each other between a first position shown in FIG. 6 and a second position shown in FIG. 3. When first and second members 32, 34 are in the first position, first surfaces on projections 78 contact lip region 50. When first and second members 32, 34 are in the second position, second surfaces on projections 78 contact shoulder region 66.

A recess 80 is defined in inner wall 34e of second member at one end of planar surface 76 and a distance further inwardly from second end 34b. Recess 80 is generally circular in shape and is configured to receive a second end of coil spring 36 therein. Recess 80 extends inwardly from inner wall 34e for a distance but does not extend all of the way to outer wall 34f. As with recess 54 the second end of the coil spring 36 may simply be seated in recess 80 or may be fixedly secured to the material which defines recess 80

An aperture 82 is defined in inner wall 34e immediately above recess 80 and further away from second end 34b. Aperture 82 extends from inner wall 34e through to outer wall 34f and is configured to receive a first end 38a of trigger 38 therein. Aperture 82 may be generally rectangular in shape or may be of any other shape that is suitable for having first end 38a of trigger 38 situated therein.

Still referring to FIGS. 12 and 13, a blade 84 and a jaw 86 extend outwardly from inner wall 34e of second member 34 and toward first member 32. Blade 84 is of a similar and complementary shape to blade 60 and jaw 86 is of similar and complementary shape to jaw 62. Blade 84 and jaw 86 also serve the same function as blade 60 and jaw 62. Blade 84 presents a planar inner face 84a and jaw presents a planar inner face 86a. Jaw 86 further includes a notch 88 that is defined in the upper surface thereof.

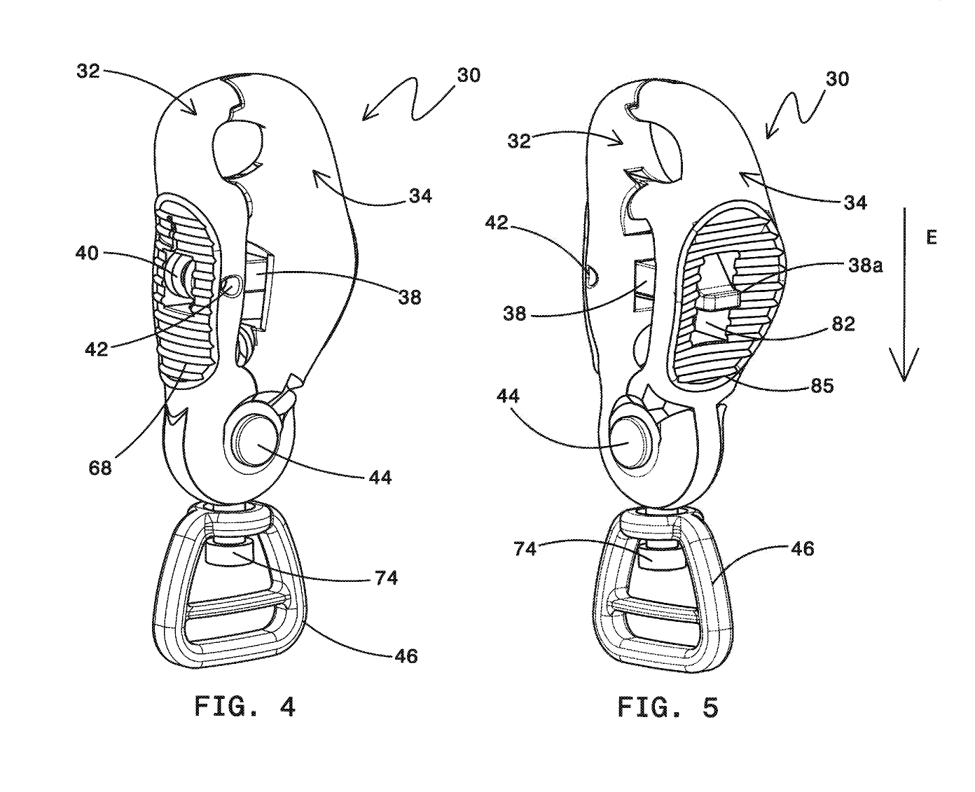

Inner wall 32e of first member 32 includes various surfaces that are complementary to the configuration of the free ends of blade and jaw 84, 86 of the second member 34. Likewise, the inner wall 34e of second member 34 includes various surfaces that are complementary to the configuration of the free ends of blade and jaw 60, 62 of first member 32. First and second members may therefore be configured so that the free ends of blades 60, 84 enter complementary sockets 61, 81 on the opposing one of the first and second members 32, 34. Similarly, the notched free ends of jaws 62, 86 are received in complementary sockets 63, 83 on the opposing one of the first and second members. Thus, when first and second member 32, 34 are engaged and moved to a closed position, as shown in FIG. 4 or 5, the free ends of blade and jaw 84, 86 slide into and become interlocked in sockets 81, 83 respectively, in inner wall 32e of first member 32. Similarly, the free ends of blade and jaw 60, 62 slide into and become interlocked in sockets 61, 63 respectively, in inner wall 34e of second member 34. Thus first and second members 32, 34 become interlocked with each other as is illustrated in FIG. 8 and cannot be accidentally separated.

Referring to FIG. 13, outer wall 34f of second member 34 defines a depression 85 therein which is bounded by an exterior rim 85a. Depression 85 may be deeper than depression 68 on first member 32. Depression 85 may be shaped and sized to approximate a top region of a person's thumb or finger. A plurality of alternating ribs 87 and troughs 89 are provided in depression 85 to provide some type of frictional surface that aids the user in gripping clasp 30. Ribs 87 and troughs 89 are oriented generally at right angles to the longitudinal axis of second member 34. Ribs and troughs 87 may be provided above and below aperture 82 and adjacent either side thereof. Aperture 82 is thus surrounded by ribs and troughs 70. Any other different frictional surface or texture may be utilized in depression to assist the user gripping clasp 30.

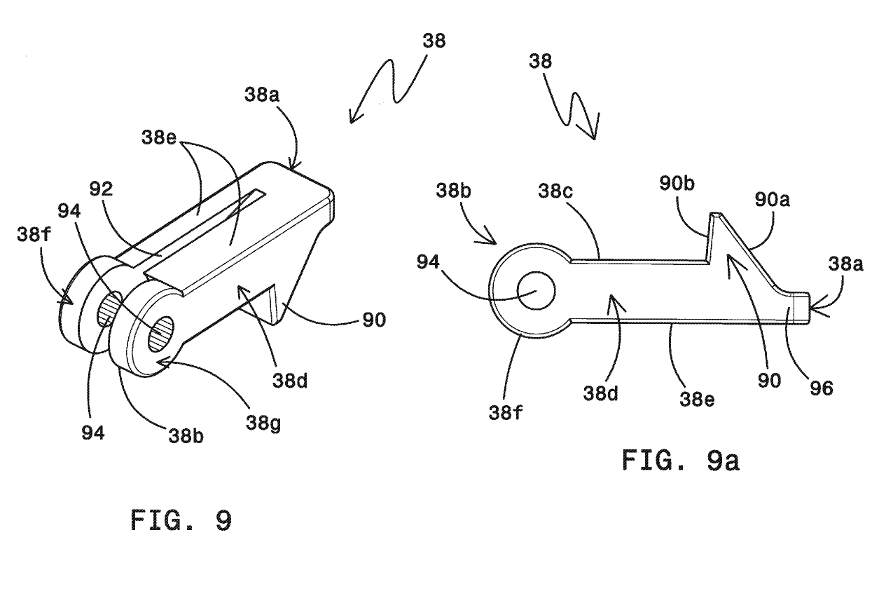

FIGS. 7 and 9 shows trigger 38 in greater detail. Trigger 38 has a first end 38a and a second end 38b and is shaped like a number “1” when viewed from the side. A V-shaped projection 90 extends outwardly from a first surface 38c of the shaft 38d a distance inwardly of first end 38a. A slot 92 is defined in the opposite surface 38e of shaft 38d from projection 90. Slot 92 divides the shaft 38d into two longitudinally extending legs, each of which terminates in a rounded terminal end 38f, 38g. A hole 94 is defined in each terminal end 38f, 38g. The holes 94 are oriented at right angles to a longitudinal axis of trigger 38, the axis being aligned with slot 92. Referring to FIG. 9a, projection 90 includes an angled face 90a and a straight face 90b. Straight face 90b is oriented generally at right angles to first surface 38c of legs 38c. Angled face 90a is oriented generally at 45 degrees relative to each of the first face 38c and straight face 90b. Trigger 38 further includes a narrowed region 96 proximate first end 38a.

Trigger 38 is secured to first member 32 in the following manner. Torsion spring 40 is positioned in the gap between terminal ends 38f and 38g of trigger 38. Torsion spring 40 is positioned so that the hole at the center of spring 40 is in alignment with holes 94 in terminal ends 38f, 38g of trigger 38. Trigger 38 with spring 40 is then engaged with first member 32 by inserting second end 38b of trigger 38 into aperture 56 in first member 32. Holes 94 in trigger 38 and the hole at the center of torsion spring 40 are aligned with holes 58 in first member and pin 42 is passed therethrough to join the various components together. The rounded terminal ends 38f, 38g ensure trigger 38 will pivot smoothly, as will be later described herein. FIG. 4 shows rounded ends 38f, 38g positioned in aperture 56 but not extending to any great distance into depression 68.

Second member 34 is engaged with first member 32 by inserting the generally circular second end 34b into slot 52 in such a manner that projections 78 are received in notches 49. Coil spring 36 is seated between the two recesses 54 and 80 and then pivot pin 44 is passed through the aligned holes 48, 72 in first and second members 32, 34. Pivot pin 44 thus ensures that first and second members 32, 34 are engaged together in such a way that they are able to pivot relative to each other. Since trigger 38 is secured to first member, when first and second members 32, 34 are engaged with each other, first end 38a of trigger 38 is positioned to be selectively inserted into aperture 82 in second member 34.

Clasp 30 is used in the following manner. Clasp 30 is biased to the open position (FIG. 6) by coil spring 36 and is therefore ready to be engaged with a ring 12 on a pet collar 10. As shown in FIG. 6, blades 60, 84 extend across the opening between first and second members 32, 34, and therefore protect trigger 38 from accidental contact by ring 12. When clasp 30 is in the open position the projections 78 on second member 34 contact lip region 50 on first member 32. Lip region 50 thus acts as a stop to prevent clasp 30 from opening beyond a certain point.

Clasp 30 is positioned proximate pet collar 10 so that jaws 62, 86 are poised to move through the aperture 12a in ring 12. The user will then grasp clasp 30 by placing their index finger in one of the depressions 68, 85 and placing their thumb in the other of the depressions 68, 85. The user will then squeeze their finger and thumb inwardly toward each other in the directions “B” and “C” indicated in FIG. 6. This motion moves jaws 62, 86 toward each other. The coil spring 36 is compressed as the gap between first and second members 32, 34 narrows. First end 38a of trigger 38 moves into aperture 82 and, as it does so, projection 90 contacts an upper wall 98 (FIGS. 8 and 12) of second member 34 which defines aperture 82. This contact causes trigger 38 to pivot about post 42, moving first end 38a of trigger 38 downwardly in the direction of arrow “D” (FIG. 6) as the trigger 38 slides further into aperture 82. Spring 40 is placed under compression by this downward motion. As is best seen in FIG. 8, upper wall 98 defines a notch 100 therein. Projection 90 clears upper wall 98 and moves into notch 100 as first and second members 32, 34 continue to be squeezed together. As projection clears the edge of upper wall which defines notch 100, spring 40 is free to return to its original shape and position and this pivots trigger 38 in the opposite direction, thereby moving first end 38a of trigger 38 upwardly in the opposite direction of arrow “D”. Projection 90 thus becomes interlocked with notch 100 in upper wall 98 and trigger 38 thus cannot be laterally withdrawn from aperture 82. Thus, first and second members 32, 34 are locked together (FIG. 3). As is evident from FIG. 5, first end 38a of trigger 30 protrudes out of aperture 82 for a short distance when first and second members 32, 34 are locked together in this fashion. It should be noted that while first end 38a of trigger 38 protrudes through aperture 82 and into depression 85, first end 38a is recessed within depression 85 relative to outer wall 34b of second member 34. Thus, in order to access first end 38a, the user has to insert a fingertip or tip of the thumb into the depression 85 in order to contact first end 38a. The recessed position of first end 38a is therefore such that trigger 38 cannot easily be dislodged by accident.

At the same time that trigger 38 is becoming interlockingly engaged with second member 34, the mating complementary surfaces on blades and jaws 60, 84 and 62, 86 on first and second members 32, 34 slide into the associated sockets 61, 81 and 63, 83. Each blade 60/84 of first and second members 32, 34 therefore also ensures that the shaft 38d of trigger 38 will not be contacted and disengaged by ring 12 of pet collar 10.

Ring 12 on pet collar 10 is thus trapped in the space 102 (FIG. 3) between the blades 60/84 and the jaws 62/86. Leash 13 is thereby secured via clasp 30 to pet collar 10 with simplicity and ease relative to previously known clips, such as the one illustrated in FIGS. 1 and 2.

When it is later desired to detach leash 13 from pet collar 10, the user will push downwardly on the first end 38a of trigger 38 which protrudes through aperture 82 (FIG. 5) so that first end 38a moves downwardly in the direction indicated by arrow “E” (FIGS. 5 and 8) and causing trigger 38 to pivot accordingly. As indicated above, the pivotal motion of trigger 38 is accomplished by the user inserting a fingertip into the depression 85 to contact first end 38a. The rotation of trigger 38 causes projection 90 to move in the direction “E”, thereby disengaging from its position within notch 100 of upper wall 98. Continued rotation of trigger 38 causes the uppermost tip 90a (FIG. 8) of projection 90 to clear upper wall 98. As soon as this occurs, coil spring 36 will expand back to its original position, forcing first ends 32a, 34a of first and second members 32, 34 to move outwardly away from each other in the opposite directions to arrows “B” and “C” in FIG. 6. Second ends 32b, 34b of first and second members 32, 34 pivot relative to each other about an axis extending along the shaft of pivot pin 44. The pivotal motion causes first ends 32a, 34a and therefore jaws 62, 86 to move away from each other. As jaws 62, 86 move away from each other, they slide out of aperture 12a and ring 12 is released. Thus, leash 13 is detached from pet collar 10.

It should be noted that trigger 38 is biased in a closed or locked direction. Thus, when first and second members 32, 34 are moved toward each other, trigger 38 will move to a position where it will stay in a locked condition unless and until the user actively moves the trigger 38 to an unlocked position by moving the first end 38a thereof in the direction “E”, as described above. If there is a load on clasp 30 when it is desired to detach leash 13 from collar 10, the user can push the entire clasp 30 inwardly toward the collar 10 to release the load and then trigger 38 will be more easily released.

Thus, clasp 30 acts like a crab pincer or claw. The jaws 62, 86 are at one end of the clasp 30. This makes it easy for a user to see how and where they need to engage ring 12 on collar 10. In the PRIOR ART devices, such as that shown in FIGS. 1 and 2, the first and second jaws 18a, 18b of the clip 10 are situated midway along a side of the clip 10 and are difficult to see when it is necessary to engage the ring 12 on collar 10. Additionally, the jaws 62, 86 of this new clasp 30 are biased into an open position, not into a closed position as is the case with PRIOR ART devices. Once trigger 38 has been depressed to open clasp 30, the clasp remains in this open condition until first and second members 32, 34 are squeezed together by the user. This is unlike PRIOR ART clips, such as that illustrated in FIGS. 1 and 2 which are biased to the closed position and have to be actively moved to the open position in order to be used. The jaws 62, 86 of clasp 30 interlock with each other for strength and this interlocking engagement makes it possible to fabricate clasp 30 out of plastic instead of metal. The jaws of the PRIOR ART devices do not contact each other at all—instead, they are linked together by a movable slider. The jaws 62, 86 of this new clasp 30 move relative to each other, moving from a wide open position to an interlocked closed position. The jaws of the PRIOR ART device are stationary and separated from each other at all times. The jaws 62, 86 of the clasp 30 do not hook back from the load direction and are less than 90 degrees from the load direction. In PRIOR ART clips, the jaws are 180 degrees from the load direction. The clasp 30 is also easy to hold and easy to operate with one hand because of the presence of the two opposed gripping areas, namely depressions 68, 85.

In one aspect, the invention may include a method of securing a pet leash 13 to a pet collar 10 which includes providing a clasp 30 having first and second members 32, 34 that are pivotally secured together at one end 32b, 34b and have opposing jaws 62, 86 at an opposite end 32a, 32b; where the jaws are biased into an open position and disposed a distance from each other as is shown in FIG. 6. The method further includes grasping the clasp 30 between a thumb and index finger of one hand; positioning the clasp 30 so that an aperture 12a (FIG. 3) in a ring 12 on the pet collar 10 is aligned with the opposing jaws 62, 86 on the clasp as is shown in FIG. 6. The method further includes squeezing the first and second members 32, 34 together (in the directions “B” and “C” of FIG. 6) to move the jaws 62, 86 toward each other and interlocking the jaws 62, 86 together so that clasp 30 is in the closed position (FIG. 3). The method further includes engaging a trigger 38 on the first member 32 in an aperture 82 on the second member 34 as the first and second members 32, 34 move toward each other in the directions “B” and “C”.

The clasp 30 is disengaged by reversing these steps.

It will be understood that clasp 30 may include only a single blade 60 or 84 and a single jaw 62 or 86 which extends between first and second members 32, 34. However, the double set of blades and jaws disclosed herein makes for a stronger interlocking connection between first and second members 32, 34.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

1. A clasp for engaging a pet leash to a pet collar; said clasp comprising:
a first member having a first end and a second end;
a second member having a first end and a second end; and
a pivot pin securing the second ends of the first and second members together; and wherein the first ends of the first and second members are selectively movable toward and away from each other; and the first ends are adapted to capture and secure a ring on the pet collar when moved toward each other and to release the ring when moved away from each other.

2. The clasp as defined in claim 1, wherein the jaws are approximately no more than 90 degrees from a load direction on the clasp.

3. The clasp as defined in claim 1, wherein the first and second members are biased into an open position.

4. The clasp as defined in claim 1, further comprising a trigger on the first member, where the trigger and extends toward the second member.

5. The clasp as defined in claim 4, wherein the trigger is movable between a locked position and an unlocked position; and when in the locked position a first end of the trigger engages the second member; and when in the unlocked position, the trigger does not engage the second member.

6. The clasp as defined in claim 4, further comprising a first blade that extends outwardly from one or the other of the first and second members in a position located between the trigger and the first ends of the first and second members.

7. The clasp as defined in claim 6, wherein the first blade is positioned on an opposite side of the one of the first and second members from the jaw on that particular first and second member.

8. The clasp as defined in claim 6, further comprising a socket formed in the other of the first and second members in a position opposite the first blade, and wherein a free end of the first blade is received in the socket when the first and second members are moved toward each other.

9. The clasp as defined in claim 1, wherein the first and second ends of the first and second members interlock with each other.

10. The clasp as defined in claim 1, further comprising a D-ring engaged with one of the second ends of the first and second members.

11. The clasp as defined in claim 10, further comprising a post that connects the D-ring to the one of the second ends of the first and second members.

12. The clasp as defined in claim 11, wherein the post extends to and is engaged by the pivot pin.

13. The clasp as defined in claim 11, wherein the first and second members are fabricated from plastic and the post is fabricated from metal.

14. The clasp as defined in claim 1, further comprising a gripping region provided on an outer wall of each of the first and second members.

15. In combination:
a pet collar adapted to be secured around a pet's neck; said collar having a ring extending outwardly therefrom; and
a pet leash having a clasp on one end, where the clasp comprises:
a first member having a first end and a second end;
a second member having a first end and a second end; and
a pivot pin securing the second ends of the first and second members together; wherein the first ends members are selectively movable toward and away from each other; and the first ends are moved toward each other to capture the ring on the pet collar; and the first ends are movable away from each other to release the ring.

16. The combination as defined in claim 15, further comprising a trigger provided on the first member, where the trigger and extends toward the second member; wherein the trigger is movable between a locked position and an unlocked position; and when in the locked position a first end of the trigger engages the second member; and when in the unlocked position, the trigger does not engage the second member.

17. The combination as defined in claim 16, further comprising a first blade that extends outwardly from one or the other of the first and second members in a position located between the trigger and the first ends of the first and second members; and wherein the first blade is positioned on an opposite side of the one of the first and second members from the jaw on that particular first and second member.

18. The combination as defined in claim 17, further comprising a socket formed in the other of the first and second members in a position opposite the first blade, and wherein a free end of the first blade is received in the socket when the first and second members are moved toward each other.

19. A method of securing a pet leash to a pet collar comprising:
providing a clasp on the pet leash, where the clasp has first and second members that are pivotally secured together at one end and have opposing jaws at an opposite end, and where the jaws are biased into an open position;
grasping the clasp between a thumb and index finger of one hand;
positioning the clasp so that an aperture in a ring on the pet collar is aligned with the opposing jaws on the clasp;
squeezing the first and second members together to move the jaws toward each other; and
interlocking the jaws together.

20. The method as defined in claim 16, wherein the step of interlocking the jaws together includes:
engaging a trigger on the first member in an aperture on the second member when the first and second members move toward each other.
